(19) United States
(12) Patent Application Publication
(10) Pub. No.: US 2025/0002124 A1
(43) Pub. Date: Jan. 2, 2025

(54) VESSEL OPERATOR WARNING SUPPORT SYSTEM AND VESSEL OPERATOR WARNING SUPPORT METHOD

(71) Applicant: YAMAHA HATSUDOKI KABUSHIKI KAISHA, Iwata-shi (JP)

(72) Inventors: Hirofumi AMMA, Shizuoka (JP); Hidenori SATAKE, Shizuoka (JP); Yukitaka OKAMOTO, Shizuoka (JP); Hideyoshi SATO, Shizuoka (JP)

(21) Appl. No.: 18/884,772

(22) Filed: Sep. 13, 2024

Related U.S. Application Data
(63) Continuation of application No. PCT/JP2023/004748, filed on Feb. 13, 2023.

(30) Foreign Application Priority Data
Mar. 16, 2022 (JP) 2022-041604

(51) Int. Cl. B63B 49/00; B63B 79/40; B63H 21/21

(52) U.S. Cl. CPC B63B 49/00; B63B 79/40; B63H 21/21; B63H 2021/216

(57) ABSTRACT

A vessel operator warning support system includes a marine vessel including an engine, a controller, and a communicator, and an information terminal configured or programmed to communicate with the communicator and to define and function as a warning application to issue a predetermined warning based on location information of the marine vessel. The controller of the marine vessel is configured or programmed to perform a control to transmit, via the communicator to the information terminal, a start signal to start the warning application when the engine is started.

### CROSS REFERENCE TO RELATED APPLICATIONS

This application claims the benefit of priority to Japanese Patent Application No. 2022-041604 filed on Mar. 16, 2022 and is a Continuation Application of PCT Application No. PCT/JP2023/004748 filed on Feb. 13, 2023. The entire contents of each application are hereby incorporated herein by reference.

### BACKGROUND OF THE INVENTION

### 1. Field of the invention

The present invention relates to vessel operator warning support systems and vessel operator warning support methods.

### 2. Description of the Related Art

A small marine vessel operable to communicate with an information terminal is known in general. Such a small marine vessel is disclosed in Japanese Patent Laid-Open No. 2015-067263, for example.

Japanese Patent Laid-Open No. 2015-067263 discloses a jet propulsion boat (small marine vessel) operable to communicate with a mobile terminal (information terminal). The jet propulsion boat disclosed in Japanese Patent Laid-Open No. 2015-067263 instructs the mobile terminal to transmit a rescue signal when a boat operator falls into the water and needs to be rescued.

Although not disclosed in Japanese Patent Laid-Open No. 2015-067263, a warning application may be installed on a mobile terminal (information terminal), with which a conventional jet propulsion boat (small marine vessel) such as the jet propulsion boat disclosed in Japanese Patent Laid-Open No. 2015-067263 is communicable, to issue to an operator of the jet propulsion boat a predetermined warning based on location information of the jet propulsion boat. The predetermined warning based on the location information of the jet propulsion boat is intended to improve the manners of the boat operator when the boat operator operates the jet propulsion boat. However, even when the warning application has been installed on the mobile terminal, the boat operator may forget to start the warning application on the mobile terminal. In such a case, when the boat operator operates the jet propulsion boat, the predetermined warning intended to improve the manners of the boat operator when the boat operator operates the jet propulsion boat is not issued to the boat operator. Therefore, it is desired to reduce or prevent the possibility that the boat operator forgets to start the warning application on the mobile terminal (information terminal) with which the jet propulsion boat is communicable to issue the predetermined warning based on the location information of the jet propulsion boat when the jet propulsion boat (small marine vessel) is operated.

### SUMMARY OF THE INVENTION

Example embodiments of the present invention provide vessel operator warning support systems and vessel operator warning support methods that each reduce or prevent the possibility that vessel operators forget to start warning applications on information terminals with which marine vessels are operable to communicate to issue predetermined warnings based on location information of the marine vessels when the vessel operators operate the marine vessels.

A vessel operator warning support system according to an example embodiment of the present invention includes a marine vessel including an engine, a controller, and a communicator, and an information terminal configured or programmed to communicate with the communicator of the marine vessel and to define and function as a warning application to issue a predetermined warning based on location information of the marine vessel. The controller of the marine vessel is configured or programmed to perform a control to transmit, via the communicator to the information terminal, a start signal to start the warning application when the engine is started.

As described above, the vessel operator warning support system includes the controller configured or programmed to perform a control to transmit, via the communicator of the marine vessel to the information terminal, the start signal to start the warning application when the engine is started. Accordingly, when the engine of the marine vessel is started, the start signal is transmitted to the information terminal to issue the predetermined warning based on the location information of the marine vessel to start the warning application. That is, even when the warning application has not been started on the information terminal, the warning application is started on the information terminal when the engine of the marine vessel is started. Consequently, the possibility that the vessel operator forgets to start the warning application on the information terminal is reduced or prevented.

In the vessel operator warning support system according to an example embodiment, the warning application is preferably operable to warn a vessel operator of the marine vessel that the marine vessel has exceeded a speed limit in a speed restricted area in which a speed of the marine vessel is restricted, and/or that the marine vessel has entered an entry prohibited area in which entry of the marine vessel is prohibited. Accordingly, the possibility that the vessel operator forgets to start the application to warn the vessel operator of the marine vessel that the marine vessel has exceeded the speed limit in the speed restricted area, and/or that the marine vessel has entered the entry prohibited area when the vessel operator operates the marine vessel is reduced or prevented.

In the vessel operator warning support system according to an example embodiment, the controller is preferably configured or programmed to perform a control to determine whether or not the engine has been started based on a rotation speed of the engine. Accordingly, for example, unlike a case in which it is determined whether or not the engine has been started based on whether or not a switch has been pressed to start the engine, it is reliably determined whether or not the engine has actually been started based on the rotation speed of the engine. Consequently, the possibility that the start signal is transmitted to the information terminal to start the warning application when the engine has not been started is reduced or prevented.

In the vessel operator warning support system according to an example embodiment, the information terminal is preferably configured or programmed to start the warning application when the start signal has been received and a current location of the information terminal is over water. Accordingly, the possibility that the warning application is started on the information terminal when the start signal has been transmitted from the marine vessel but the current location of the marine vessel or the information terminal is on land is reduced or prevented. That is, the possibility that the warning application is started on the information terminal when the start signal has been transmitted from the marine vessel but the vessel operator does not operate the marine vessel is reduced or prevented. Consequently, the possibility that the warning application is started on the information terminal when it is not necessary to start the warning application on the information terminal is reduced or prevented.

In such a case, the information terminal is preferably configured or programmed to acquire location information of the information terminal using a satellite positioning system, and to not start the warning application when it is determined that the information terminal is on land based on the location information of the information terminal even when the start signal has been transmitted from the marine vessel.

Accordingly, the information terminal easily determines whether or not the information terminal is on land based on the location information of the information terminal acquired by the satellite positioning system. That is, the information terminal easily determines whether or not the warning application is started. Consequently, the possibility that the warning application is started on the information terminal when it is not necessary to start the warning application on the information terminal is easily reduced or prevented. Furthermore, the information terminal (especially a portable information terminal) often includes the function of the satellite positioning system (such as a GPS), and thus in such a case, it is not necessary to install new software for the satellite positioning system on the information terminal.

In the vessel operator warning support system according to an example embodiment, the controller is preferably configured or programmed to acquire the location information of the marine vessel using a satellite positioning system, and to perform a control to not transmit the start signal to the information terminal when the controller determines that the marine vessel is on land based on the location information of the marine vessel even when the engine has been started. Accordingly, the controller easily determines whether or not the marine vessel is on land based on the location information of the marine vessel acquired by the satellite positioning system. That is, the controller easily determines whether or not the start signal is transmitted to the information terminal to start the warning application. Consequently, the possibility that the warning application is started on the information terminal when it is not necessary to start the warning application on the information terminal is easily reduced or prevented.

In the vessel operator warning support system according to an example embodiment, the marine vessel preferably includes a jet propulsion thruster to generate a thrust using a driving force of the engine, and the controller is preferably configured or programmed to perform a control to not transmit the start signal to the information terminal when the controller determines that the marine vessel is on land by estimating whether or not the thruster is underwater based on a load on the engine even when the engine has been started. Accordingly, the controller easily determines whether or not the marine vessel is on land by estimating whether or not the jet propulsion thruster is underwater based on the load on the engine. That is, the controller easily determines whether or not the start signal is transmitted to the information terminal to start the warning application. Consequently, the possibility that the warning application is started on the information terminal when it is not necessary to start the warning application on the information terminal is easily reduced or prevented.

In the vessel operator warning support system according to an example embodiment, the controller is preferably configured or programmed to perform a control to transmit the start signal to the information terminal via the communicator using short-range wireless technology, such as Bluetooth™ (registered trademark) when the engine is started. Accordingly, using, for example, Bluetooth™, which is optimal for short-distance communication, the start signal is easily transmitted from the communicator of the marine vessel to the information terminal.

In the vessel operator warning support system according to an example embodiment, the controller is preferably configured or programmed to perform a control to limit an output of the engine or a speed of the marine vessel when the warning application has not been started on the information terminal. Even with the warning application of the information terminal, the warning application may not function when the vessel operator operates the marine vessel. The warning application may not function, for example, when the information terminal is not on, when communication between the communicator of the marine vessel and the information terminal is not established, when the warning application is not started, etc. The warning application is not started, for example, when the warning application is not started normally on the information terminal even when the marine vessel has transmitted the start signal to the information terminal to start the warning application, when the vessel operator (intentionally or unintentionally) stops the warning application that has been started on the information terminal, etc. When the warning application does not function when the vessel operator is operating the marine vessel, the warning application of the information terminal is not effectively used to issue the predetermined warning based on the location information of the marine vessel. Therefore, it is desired to allow the warning application to function on the information terminal to issue the predetermined warning based on the location information of the marine vessel when the vessel operator operates the marine vessel. In this regard, with the structure described above, the output of the engine or the speed of the marine vessel is limited when the warning application has not been started on the information terminal. That is, when the warning application has not been started on the information terminal, the vessel operator is prompted to start the warning application on the information terminal in order to cancel the limitation on the output of the engine or the speed of the marine vessel. Consequently, when the vessel operator operates the marine vessel, the warning application is allowed to function on the information terminal to issue the predetermined warning based on the location information of the marine vessel.

In the structure in which the controller performs a control to limit the output of the engine when the warning application has not been started on the information terminal, the controller is preferably configured or programmed to perform a control to limit a rotation speed of the engine so as to limit the output of the engine when the warning application has not been started on the information terminal. Accordingly, the output of the engine is easily limited by limiting the rotation speed of the engine. Consequently, when the vessel operator operates the marine vessel, the warning application is easily allowed to function on the information terminal to issue the predetermined warning based on the location information of the marine vessel.

In the structure in which the controller performs a control to limit the output of the engine when the warning application has not been started on the information terminal, the controller is preferably configured or programmed to perform a control to limit a maximum output of the engine to at least about 40% and not more than about 70% of a maximum output of the engine on which a limitation is not imposed when the warning application has not been started on the information terminal. Accordingly, the output of the engine is limited to a greater extent as compared with a case in which the maximum output of the engine is limited to more than about 70% of the maximum output of the engine on which a limitation is not imposed. That is, when the warning application has not been started on the information terminal, the vessel operator is more strongly prompted to start the warning application on the information terminal. Consequently, when the vessel operator operates the marine vessel, the warning application is reliably allowed to function on the information terminal to issue the predetermined warning based on the location information of the marine vessel.

In the vessel operator warning support system according to an example embodiment, the information terminal preferably includes a touch panel, and is preferably configured or programmed to lock or unlock a screen transition on the touch panel when the touch panel receives a first operation of drawing a figure clockwise and a second operation of drawing a figure counterclockwise in succession while the warning application is displayed on the touch panel. When the vessel operator operates the marine vessel, water droplets may adhere to the information terminal. In such a case, when the water droplets move on the touch panel due to their own weight, wind pressure, or the like while the warning application is displayed on the touch panel, the information terminal may erroneously recognize that the touch panel has been operated by the vessel operator. In such a case, the screen of the warning application displayed on the touch panel is transitioned to another screen without the intention of the vessel operator. Therefore, it is desired to reduce or prevent the transition of the screen of the warning application displayed on the touch panel of the information terminal to another screen without the intention of the vessel operator. In this regard, with the structure described above, the screen transition on the touch panel is locked or unlocked only when the first operation of drawing a figure clockwise and the second operation of drawing a figure counterclockwise are performed in succession on the touch panel while the warning application is displayed on the touch panel. It is considered that it is unlikely that a water droplet on the touch panel will move to draw a figure counterclockwise following moving to draw a figure clockwise. That is, it is difficult for a water droplet on the touch panel to move in the same way as the finger of the vessel operator in the first operation and the second operation to lock or unlock the screen transition on the touch panel, and thus the possibility that the information terminal erroneously recognizes that the touch panel has been operated by the vessel operator while the warning application is displayed on the touch panel is reduced or prevented. Consequently, the transition of the screen of the warning application displayed on the touch panel of the information terminal to another screen without the intention of the vessel operator is reduced or prevented.

In the structure in which the information terminal locks or unlocks the screen transition on the touch panel when the touch panel receives the first operation of drawing a figure clockwise and the second operation of drawing a figure counterclockwise in succession while the warning application is displayed on the touch panel, the information terminal is preferably configured or programmed to lock or unlock the screen transition on the touch panel when the touch panel receives the first operation and the second operation of drawing the figure of a different size from the figure of the first operation in succession while the warning application is displayed on the touch panel. Accordingly, as compared with a case in which a figure of the same size is drawn in the first operation and the second operation, it is more difficult for a water droplet on the touch panel to move in the same way as the finger of the vessel operator in the first operation and the second operation, and thus the possibility that the information terminal erroneously recognizes that the touch panel has been operated by the vessel operator is further reduced or prevented. Consequently, the transition of the screen of the warning application displayed on the touch panel of the information terminal to another screen without the intention of the vessel operator is further reduced or prevented.

In the structure in which the information terminal locks or unlocks the screen transition on the touch panel when the touch panel receives the first operation of drawing a figure clockwise and the second operation of drawing a figure counterclockwise in succession while the warning application is displayed on the touch panel, the information terminal is preferably configured or programmed to lock or unlock the screen transition on the touch panel when the touch panel receives the first operation of drawing a circle and the second operation of drawing a circle in succession while the warning application is displayed on the touch panel. Accordingly, as compared with a case in which a figure (such as a quadrangle or a triangle) other than a circle is drawn in the first operation and the second operation, the number of strokes of the figure drawn in the first operation and the second operation is smaller, and thus the operational burden on the vessel operator to lock or unlock the screen transition on the touch panel is reduced.

In the structure in which the information terminal locks or unlocks the screen transition on the touch panel when the touch panel receives the first operation of drawing a figure clockwise and the second operation of drawing a figure counterclockwise in succession while the warning application is displayed on the touch panel, the information terminal is preferably configured or programmed to lock or unlock the screen transition on the touch panel when the touch panel receives, in succession, the first operation and the second operation performed adjacent to each other so as to draw a figure eight while the warning application is displayed on the touch panel. Accordingly, a figure eight is drawn through the first operation and the second operation such that the number of strokes of the figure drawn through the first operation and the second operation is reduced to one, and thus as compared with a case in which a figure eight is not drawn through the first operation and the second operation, the operational burden on the vessel operator to lock or unlock the screen transition on the touch panel is reduced.

A vessel operator warning support method according to another example embodiment of the present invention includes determining with a controller of a marine vessel including an engine, the controller, and a communicator, whether or not the engine has been started, and performing with the controller of the marine vessel a control to transmit, via the communicator of the marine vessel to an information terminal configured or programmed to communicate with the communicator and to define and function as a warning application to issue a predetermined warning based on location information of the marine vessel, a start signal to start the warning application when the controller determines that the engine has been started.

As described above, the vessel operator warning support method includes performing with the controller a control to transmit, via the communicator of the marine vessel to the information terminal configured or programmed to communicate with the communicator and to define and function as the warning application to issue the predetermined warning based on the location information of the marine vessel, the start signal to start the warning application when the controller determines that the engine of the marine vessel has been started.

Accordingly, similarly to the vessel operator warning support system according to an example described above, even when the warning application has not been started on the information terminal, the warning application is started on the information terminal when the engine of the marine vessel is started.

Consequently, similarly to the vessel operator warning support system described above, the possibility that the vessel operator forgets to start the warning application on the information terminal to issue the predetermined warning based on the location information of the marine vessel when the vessel operator operates the marine vessel is reduced or prevented.

The vessel operator warning support method preferably includes determining whether or not the warning application has been started on the information terminal, and performing with the controller a control to limit an output of the engine or a speed of the marine vessel when the warning application has not been started on the information terminal. Accordingly, similarly to the vessel operator warning support system described above, when the warning application has not been started on the information terminal, the vessel operator is prompted to start the warning application on the information terminal in order to cancel the limitation on the output of the engine or the speed of the marine vessel. Consequently, similarly to the vessel operator warning support system described above, when the vessel operator operates the marine vessel, the warning application is allowed to function on the information terminal to issue the predetermined warning based on the location information of the marine vessel.

The vessel operator warning support method preferably includes determining whether or not a touch panel of the information terminal has received a first operation of drawing a figure clockwise and a second operation of drawing a figure counterclockwise in succession while the warning application is displayed on the touch panel, and locking or unlocking a screen transition on the touch panel when the touch panel has received the first operation and the second operation in succession while the warning application is displayed on the touch panel. Accordingly, similarly to the vessel operator warning support system described above, it is difficult for a water droplet on the touch panel to move in the same way as the finger of the vessel operator in the first operation and the second operation to lock or unlock the screen transition on the touch panel, and thus the possibility that the information terminal erroneously recognizes that the touch panel has been operated by the vessel operator while the warning application is displayed on the touch panel is reduced or prevented. Consequently, similarly to the vessel operator warning support system described above, the transition of the screen of the warning application displayed on the touch panel of the information terminal to another screen without the intention of the vessel operator is reduced or prevented.

Another example embodiment of the present invention may include a vessel operator warning support system including a marine vessel including an engine, a controller, and a communicator, and an information terminal configured or programmed to communicate with the communicator of the marine vessel and to define and function as a warning application to issue a predetermined warning based on location information of the marine vessel, and the controller of the marine vessel is configured or programmed to perform a control to limit an output of the engine or a speed of the marine vessel when the warning application has not been started on the information terminal. As described above, it is desired to reliably allow the warning application to function on the information terminal to issue the predetermined warning based on the location information of the marine vessel when the vessel operator operates the marine vessel. Therefore, with the structure described above, the output of the engine or the speed of the marine vessel is limited when the warning application has not been started on the information terminal. That is, when the warning application has not been started on the information terminal, the vessel operator is prompted to start the warning application on the information terminal in order to cancel the limitation on the output of the engine or the speed of the marine vessel. Consequently, when the vessel operator operates the marine vessel, the warning application is reliably allowed to function on the information terminal to issue the predetermined warning based on the location information of the marine vessel.

According to example embodiments of the present invention, as described above, the vessel operator warning support systems and the vessel operator warning support methods are provided that each reduce or prevent the possibility the boat operators forget to start the warning applications on the information terminals with which the marine vessels are operable to communicate to issue the predetermined warnings based on the location information of the marine vessels when the vessel operators operate the marine vessels.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a block diagram of a vessel operator warning support system according to an example embodiment of the present invention.

FIG. 2 is a side view of a small marine vessel according to an example embodiment of the present invention.

FIG. 3 is a diagram showing a warning screen on a touch panel of an information terminal according to an example embodiment of the present invention when a small marine vessel exceeds a speed limit in a speed restricted area.

FIG. 4 is a diagram showing a warning screen on a touch panel of an information terminal according to an example embodiment of the present invention when a small marine vessel enters an entry prohibited area.

FIG. 5 is a diagram showing a control flow for a small marine vessel to automatically start a warning application when a vessel operator operates the small marine vessel in a vessel operator warning support system according to an example embodiment of the present invention.

FIG. 6 is a diagram showing a control flow for an information terminal to automatically start a warning application when a vessel operator operates a small marine vessel in a vessel operator warning support system according to an example embodiment of the present invention.

FIG. 7 is a diagram showing a control flow to prompt a vessel operator to start a warning application when a vessel operator operates a small marine vessel in a vessel operator warning support system according to an example embodiment of the present invention.

FIG. 8 is a diagram illustrating operations to lock or unlock a screen transition of a warning application in a vessel operator warning support system according to an example embodiment of the present invention.

FIG. 9 is a diagram showing a control flow to lock or unlock a screen transition of a warning application in a vessel operator warning support system according to an example embodiment of the present invention.

FIG. 10 is a diagram illustrating operations to lock or unlock a screen transition of a warning application in a vessel operator warning support system according to a first modified example of the present invention.

FIG. 11 is a diagram illustrating operations to lock or unlock a screen transition of a warning application in a vessel operator warning support system according to a second modified example of the present invention.

FIG. 12 is a diagram illustrating operations to lock or unlock a screen transition of a warning application in a vessel operator warning support system according to a third modified example of the present invention.

FIG. 13 is a diagram illustrating operations to lock or unlock a screen transition of a warning application in a vessel operator warning support system according to a fourth modified example of the present invention.

FIG. 14 is a diagram showing a control flow to prompt a vessel operator to start a warning application when a vessel operator operates a small marine vessel in a vessel operator warning support system according to a fifth modified example of the present invention.

### DETAILED DESCRIPTION OF THE EXAMPLE EMBODIMENTS

Example embodiments of the present invention are hereinafter described with reference to the drawings.

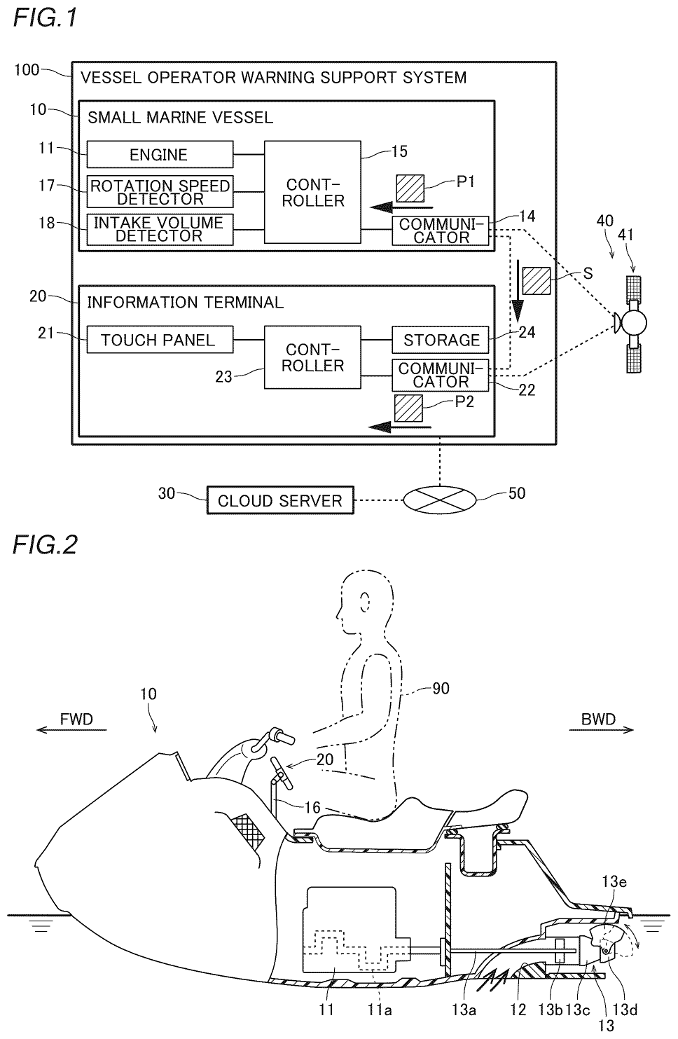

A vessel operator warning support system 100, a small marine vessel 10, and a vessel operator warning support method according to example embodiments of the present invention are now described with reference to FIGS. 1 to 9.

As shown in FIG. 1, the vessel operator warning support system 100 includes the small marine vessel 10 and an information terminal 20. The small marine vessel 10 and the information terminal 20 are operable to communicate with each other.

As shown in FIG. 2, the small marine vessel 10 may be a water jet propulsion boat (wet bike). In other words, the small marine vessel 10 may be a personal watercraft. The small marine vessel 10 includes an engine 11 and a jet propulsion thruster 13 to generate a thrust using the driving force of the engine 11. In FIG. 2, arrow FWD and arrow BWD indicate the front side and the rear side of the small marine vessel 10, respectively.

The engine 11 includes a crankshaft 11a. The engine 11 obtains a driving force to rotate the crankshaft 11a by burning a mixture of air drawn in through an intake passage (not shown) provided in a throttle valve (not shown) and fuel in a combustion chamber.

The thruster 13 is driven by the engine 11 to take water into a water passage 12 including an opening on the lower surface of the rear of the small marine vessel 10, and to eject the taken-in water from a nozzle 13c located at a rear end of the small marine vessel 10. Consequently, the small marine vessel 10 is propelled.

Specifically, the thruster 13 includes a drive shaft 13a, an impeller 13b, the nozzle 13c, a deflector 13d, and a reverse gate (bucket) 13e.

The drive shaft 13a extends in a forward-rearward direction, and includes a front end connected to the crankshaft 11a and a rear end in the water passage 12. The impeller 13b is fixed near the vicinity of the rear end of the drive shaft 13a.

The impeller 13b rotates together with the drive shaft 13a to generate a flow toward the nozzle 13c within the water passage 12.

The nozzle 13c is located at the most downstream location in the water passage 12 in which the impeller 13b is located. The nozzle 13c functions as a water outlet (jetting port). In other words, the nozzle 13c ejects water to generate a propulsive force. The deflector 13d and the reverse gate 13e are installed on the nozzle 13c.

The deflector 13d is rotatable in a right-left direction about an axis extending in an upward-downward direction. That is, the deflector 13d is operable to change the direction of the water ejected from the nozzle 13c in the right-left direction.

The reverse gate 13e is rotatable in the upward-downward direction about an axis extending in the right-left direction. In other words, the reverse gate 13e is operable to change the direction of the water ejected from the nozzle 13c in the forward-rearward direction.

As shown in FIG. 1, the small marine vessel 10 includes a communicator 14. The communicator 14 is operable to communicate with the information terminal 20 using, for example, Bluetooth™. The communicator 14 is operable to communicate with a global navigation satellite system (GNSS) satellite 41. The GNSS satellite 41 is an artificial satellite of a satellite positioning system 40.

The small marine vessel 10 includes a controller 15. The controller 15 includes a central processing unit (CPU), a read-only memory (ROM), and a random access memory (RAM), for example. The controller 15 controls driving of the engine 11, etc. The controller 15 is configure or programmed to acquire location information P1 of the small marine vessel 10 by the satellite positioning system 40 via the communicator 14.

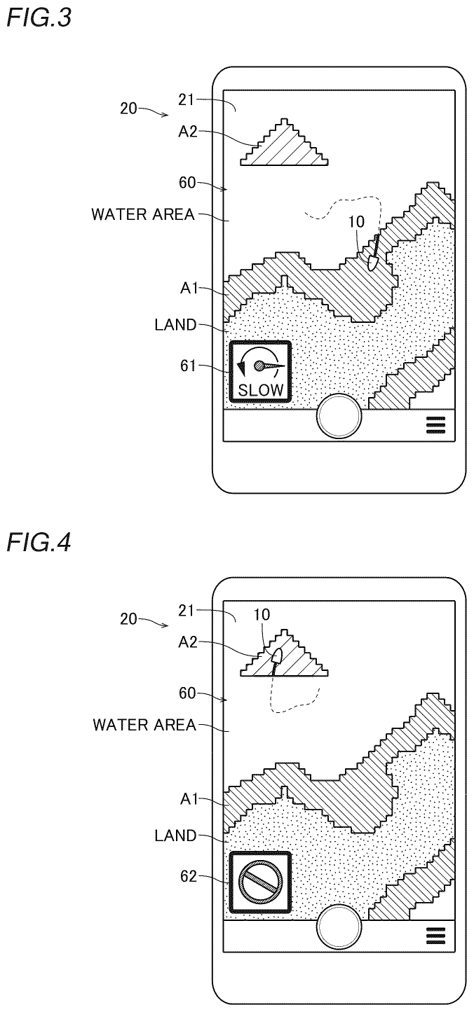

As shown in FIG. 3, the information terminal 20 may be a smartphone or a tablet terminal, for example. The information terminal 20 includes a touch panel 21. On the touch panel 21, a screen of a warning application 60 and the like is displayed. As shown in FIG. 1, the information terminal 20 is attached to the small marine vessel 10 by a bracket 13 located in front of a seat on which a vessel operator 90 sits. The warning application 60 is described below in detail.

The information terminal 20 includes a communicator 22. The communicator 22 is operable to communicate with the small marine vessel 10 (communicator 14) using, for example, Bluetooth™. The communicator 22 is operable to communicate with the GNSS satellite 41. The information terminal 20 is configured or programmed to acquire location information P2 of the information terminal 20 using the satellite positioning system 40 via the communicator 22. The communicator 22 is operable to communicate with a cloud server 30 via the Internet 50 using a communication standard such as Wi-Fi (registered trademark). The cloud server 30 stores the latest information on the warning application 60 (see FIG. 3), etc. The information terminal 20 acquires the latest information on the warning application 60, etc. from the cloud server 30 via the Internet 50.

The information terminal 20 includes a controller 23 and a storage 24. The controller 15 includes a CPU, a ROM, and a RAM, for example. The storage 24 stores a program used by the controller 15. The storage 24 stores the warning application 60 (see FIG. 3) to issue a predetermined warning based on the location information P1 of the small marine vessel 10. That is, the information terminal 10 includes the warning application 60.

As shown in FIGS. 3 and 4, the warning application 60 warns the vessel operator 90 (see FIG. 1) of the small marine vessel 10 that the small marine vessel 10 has exceeded a speed limit in a speed restricted area A1 and/or that the small marine vessel 10 has entered an entry prohibited area A2 in which entry of the small marine vessel 10 is prohibited. Information such as map information and the location information of the small marine vessel 10 is displayed on the screen of the warning application 60. The map information includes land, a water area, the speed restricted area A1, the entry prohibited area A2, etc.

FIG. 3 shows a state in which the small marine vessel 10 exceeds the speed limit in the speed restricted area A1 on the screen of the warning application 60. That is, FIG. 3 shows a state in which an icon 61 is displayed on the screen of the warning application 60 to warn the vessel operator 90 (see FIG. 1) that the small marine vessel 10 exceeds the speed limit in the speed restricted area A1. FIG. 4 shows a state in which the small marine vessel 10 enters the entry prohibited area A2 on the screen of the warning application 60. That is, FIG. 4 shows a state in which an icon 62 is displayed on the screen of the warning application 60 to warn the vessel operator 90 that the small marine vessel 10 enters the entry prohibited area A2. The warning to the vessel operator 90 may be issued by voice from the information terminal 20, may be issued by voice from the small marine vessel 10, or may be displayed on a display (not shown) of the small marine vessel 10 as an icon, a message, or the like.

As shown in FIG. 1, the controller 15 of the small marine vessel 10 performs a control to transmit, to the information terminal 20 via the communicator 14 (using, for example, Bluetooth™), a start signal S to start the warning application 60 (see FIG. 3) when the engine 11 is started. Specifically, the controller 15 determines whether or not the engine 11 has been started. When the controller 15 determines that the engine 11 has been started, the controller 15 performs a control to transmit, to the information terminal 20 via the communicator 14 operable to communicate with the information terminal 20 using Bluetooth™, the start signal S to start the warning application 60.

The controller 15 of the small marine vessel 10 performs a control to determine whether or not the engine 11 has been started based on the rotation speed of the engine 11. Specifically, the small marine vessel 10 includes a rotation speed detector 17 to detect the rotation speed of the crankshaft 11a (see FIG. 2). The controller 15 uses the rotation speed of the crankshaft 11a detected by the rotation speed detector 17 as the rotation speed of the engine 11 and determines that the engine 11 has been started when the rotation speed of the crankshaft 11a becomes greater than a predetermined threshold.

The information terminal 20 starts the warning application 60 (see FIG. 3) when the start signal S has been received and the current location of the information terminal 20 is over water. Specifically, even when the start signal S has been transmitted from the small marine vessel 10, the information terminal 20 does not start the warning application 60 when it is determined that the information terminal 20 is on land based on the location information P2 of the information terminal 20. More specifically, the controller 23 of the information terminal 20 determines whether or not the start signal S has been received. When the controller 23 determines that the start signal S has been received, the controller 23 determines whether or not the current location of the information terminal 20 is over water based on the location information P2 of the information terminal 20 acquired by the satellite positioning system 40. When the controller 23 determines that the current location of the information terminal 20 is not over water (is on land), the controller 23 performs a control to not start the warning application 60.

The controller 15 of the small marine vessel 10 performs a control to not transmit the start signal S to the information terminal 20 when the controller 15 determines that the small marine vessel 10 is on land based on the location information P1 of the small marine vessel 10 even when the engine 11 has been started. Specifically, when the controller 15 determines that the engine 11 has been started, the controller 15 determines whether or not the small marine vessel 10 is over water based on the location information P1 of the small marine vessel 10 acquired by the satellite positioning system 40. When the controller 15 determines that the small marine vessel 10 is not over water (is on land), the controller 15 performs a control to not transmit, to the information terminal 20, the start signal S to start the warning application 60 (see FIG. 3).

The controller 15 of the small marine vessel 10 performs a control to not transmit the start signal S to the information terminal 20 when the controller 15 determines that the small marine vessel 10 is on land by estimating whether or not the thruster 13 (see FIG. 2) is underwater based on the load on the engine 11 even when the engine 11 has been started. Specifically, the rotation speed of the engine 11 (the rotation speed of the crankshaft 11a) relative to the intake volume of the engine 11 when the jet propulsion thruster 13 is underwater is significantly different from that when the jet propulsion thruster 13 is not underwater. In other words, the load on the engine 11 when the jet propulsion thruster 13 is underwater is significantly different from that when the jet propulsion thruster 13 is not underwater. Therefore, the small marine vessel 10 includes an intake volume detector 18 to detect the intake volume of the engine 11. When the controller 15 determines that the engine 11 has been started, the controller 15 estimates whether or not the thruster 13 is underwater based on the intake volume of the engine 11 detected by the intake volume detector 18 and the rotation speed of the engine 11 (the rotation speed of the crankshaft 11a) detected by the rotation speed detector 17. When the controller 15 estimates that the thruster 13 is not underwater (is on land), the controller 15 performs a control to not transmit, to the information terminal 20, the start signal S to start the warning application 60 (see FIG. 3).

As shown in FIG. 5, in step S11, the controller 15 of the small marine vessel 10 determines whether or not the engine 11 has been started based on the rotation speed of the engine 11. When the controller 15 of the small marine vessel 10 determines that the engine 11 has been started, the controller 15 advances to step S12. When the controller 15 of the small marine vessel 10 determines that the engine 11 has not been started, the controller 15 returns to step S11.

Then, in step S12, the controller 15 of the small marine vessel 10 determines whether or not the small marine vessel 10 is over water based on the location information P1 of the small marine vessel 10 and the load on the engine 11. When the controller 15 of the small marine vessel 10 determines that the small marine vessel 10 is over water, the controller 15 advances to step S13. When the controller 15 of the small marine vessel 10 determines that the small marine vessel 10 is not over water (is on land), the controller 15 returns to step S11.

Then, in step S13, the controller 15 of the small marine vessel 10 performs a control to transmit, to the information terminal 20 via the communicator 14, the start signal S to start the warning application 60. Then, the controller 15 of the small marine vessel 10 returns to step S11.

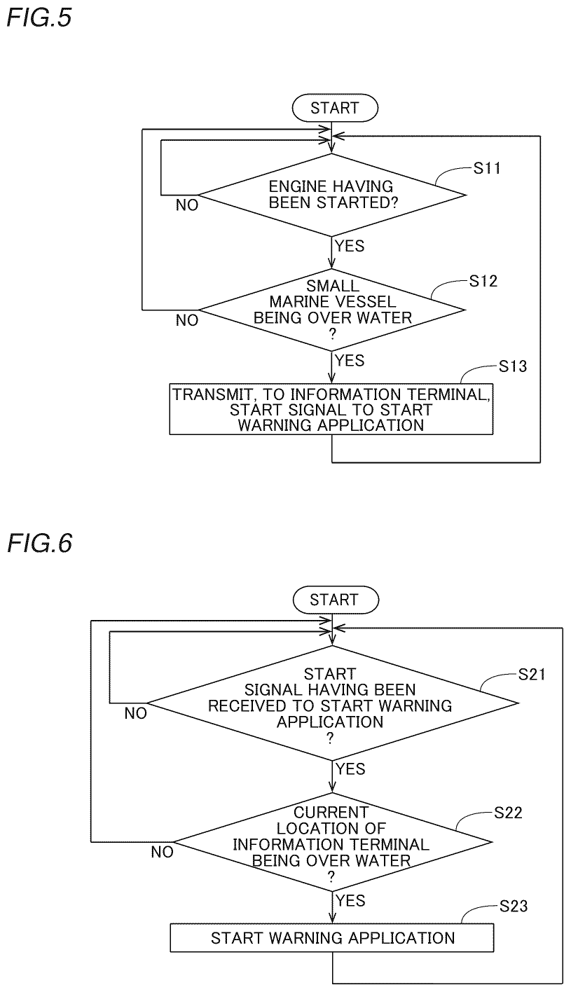

As shown in FIG. 6, in step S21, the controller 23 of the information terminal 20 determines whether or not the start signal S has been received to start the warning application 60. When the controller 23 of the information terminal 20 determines that the start signal S has been received, the controller 23 advances to step S22. When the controller 23 of the information terminal 20 determines that the start signal S has not been received, the controller 23 returns to step S21.

Then, in step S22, the controller 23 of the information terminal 20 determines whether or not the current location of the information terminal 20 is over water. When the controller 23 of the information terminal 20 determines that the current location of the information terminal 20 is over water, the controller 23 advances to step S23. When the controller 23 of the information terminal 20 determines that the current location of the information terminal 20 is not over water, the controller 23 returns to step S21.

Then, in step S23, the controller 23 of the information terminal 20 performs a control to start the warning application 60. Then, the controller 23 of the information terminal 20 returns to step S21.

As shown in FIG. 1, the controller 15 of the small marine vessel 10 performs a control to limit the output of the engine 11 when the warning application 60 (see FIG. 3) has not been started on the information terminal 20. Specifically, the controller 15 of the small marine vessel 10 performs a control to limit the rotation speed of the engine 11 so as to limit the output of the engine 11 when the warning application 60 has not been started on the information terminal 20. More specifically, the controller 15 of the small marine vessel 10 determines whether or not the warning application 60 has been started on the information terminal 20. For example, the controller 15 of the small marine vessel 10 transmits, to the information terminal 20, a signal to confirm the start of the warning application 60, and determines whether or not the warning application 60 has been started on the information terminal 20 based on information returned from the information terminal 20. When the warning application 60 has not been started on the information terminal 20, the controller 15 of the small marine vessel 10 performs a control to limit the rotation speed of the engine 11.

When the controller 15 of the small marine vessel 10 performs a control to limit the rotation speed of the engine 11, the controller 15 performs a control to notify the vessel operator 90 that a control is performed to limit the rotation speed of the engine 11 because the warning application 60 has not been started on the information terminal 20, simultaneously with performing a control to limit the rotation speed of the engine 11. The vessel operator 90 may be notified by displaying an icon, a message, or the like on the touch panel 21 of the information terminal 20, by voice from the information terminal 20, by displaying an icon, a message, or the like on the display (not shown) of the small marine vessel 10, or by voice from the small marine vessel 10.

The controller 15 of the small marine vessel 10 performs a control to limit the maximum output of the engine 11 (the maximum rotation speed of the engine 11) to at least about 40% and not more than about 70% of the maximum output (maximum rotation speed) of the engine 11 (i.e., on which a limitation is not imposed) when the warning application 60 has not been started on the information terminal 20.

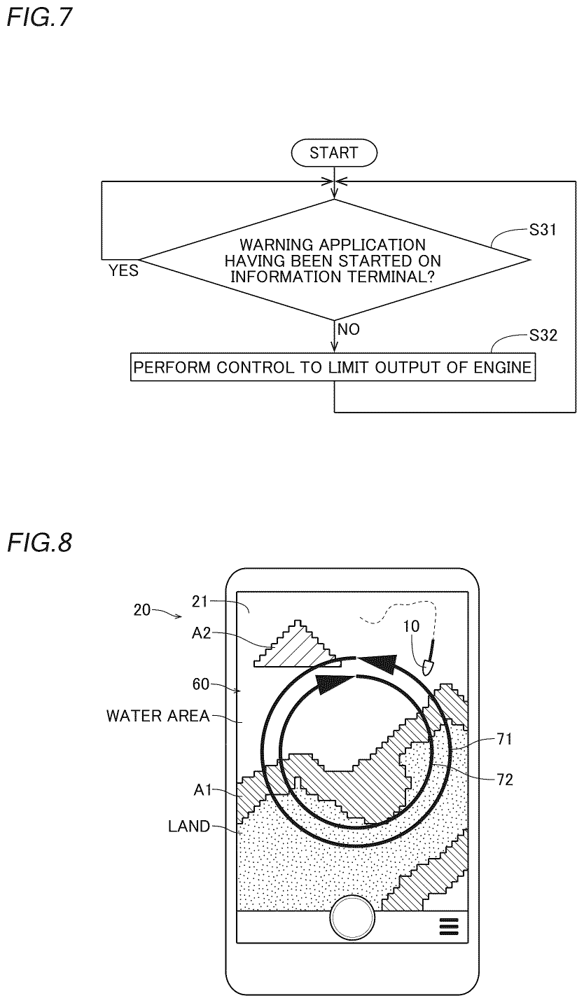

As shown in FIG. 7, in step S31, the controller 15 of the small marine vessel 10 determines whether or not the warning application 60 has been started on the information terminal 20. When the controller 15 of the small marine vessel 10 determines that the warning application 60 has been started on the information terminal 20, the controller 15 returns to step S31. When the controller 15 of the small marine vessel 10 determines that the warning application 60 has not been started on the information terminal 20, the controller 15 advances to step S32.

Then, in step S32, the controller 15 of the small marine vessel 10 performs a control to limit the output of the engine 11 (the rotation speed of the engine 11). Specifically, the controller 15 of the small marine vessel 10 performs a control to limit the maximum output of the engine 11 (the maximum rotation speed of the engine 11) to at least about 40% and not more than about 70% of the maximum output (maximum rotation speed) of the engine 11. Then, the controller 15 of the small marine vessel 10 returns to step S31.

As shown in FIG. 8, the information terminal 20 locks or unlocks screen transitions on the touch panel 21 when the touch panel 21 receives a first operation 71 of drawing a figure clockwise and a second operation 72 of drawing a figure counterclockwise in succession while the warning application 60 is displayed on the touch panel 21. Specifically, the controller 23 of the information terminal 20 determines whether or not the touch panel 21 has received the first operation 71 of drawing a figure clockwise and the second operation 72 of drawing a figure counterclockwise in succession while the warning application 60 is displayed on the touch panel 21. When the controller 23 of the information terminal 20 determines that the first operation 71 and the second operation 72 have been received in succession, the controller 23 locks or unlocks screen transitions on the touch panel 21. For example, when the second operation 72 is performed in less than one second after the first operation 71 without the vessel operator 90 removing his/her finger from the screen, the controller 23 of the information terminal 20 determines that the first operation 71 and the second operation 72 have been received in succession.

The information terminal 20 locks or unlocks screen transitions on the touch panel 21 when the touch panel 21 receives the first operation 71 and the second operation 72 of drawing a figure of a different size from the figure of the first operation 71 in succession while the warning application 60 is displayed on the touch panel 21. The information terminal 20 locks or unlocks screen transitions on the touch panel 21 when the touch panel 21 receives the first operation 71 of drawing a circle and the second operation 72 of drawing a circle in succession while the warning application 60 is displayed on the touch panel 21. In the second operation 72 of drawing a figure counterclockwise on the information terminal 20, a figure smaller than the figure of the first operation 71 of drawing a figure clockwise is drawn. Furthermore, in the second operation 72 of drawing a figure counterclockwise on the information terminal 20, a concentric circle with the first operation 71 of drawing a figure clockwise is drawn.

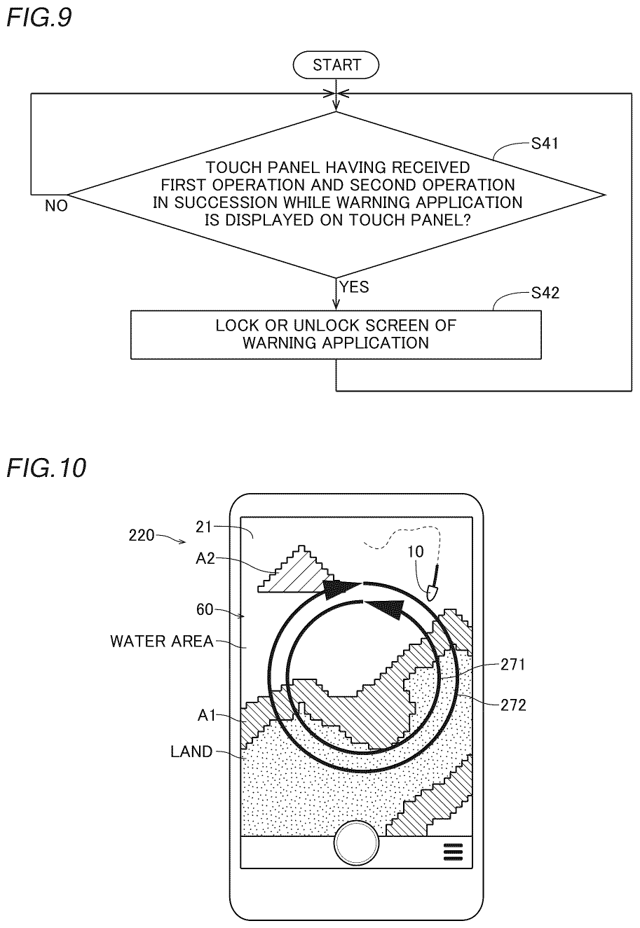

As shown in FIG. 9, in step S41, the controller 23 of the information terminal 20 determines whether or not the touch panel 21 has received the first operation 71 of drawing a figure clockwise and the second operation 72 of drawing a figure counterclockwise in succession while the warning application 60 is displayed on the touch panel 21 of the information terminal 20. When the controller 23 of the information terminal 20 determines that the touch panel 21 has received the first operation 71 and the second operation 72 in succession, the controller 23 advances to step S42. When the controller 23 of the information terminal 20 determines that the touch panel 21 has not received the first operation 71 and the second operation 72 in succession, the controller 23 returns to step S41. The first operation 71 and the second operation 72 are operations of drawing figures of different sizes. The first operation 71 and the second operation 72 are both operations of drawing circles.

Then, in step S42, the controller 23 of the information terminal 20 locks or unlocks screen transitions on the touch panel 21. Then, the controller 23 of the information terminal 20 returns to step S41.

According to the various example embodiments of the present invention described above, the following advantageous effects are achieved.

According to an example embodiment of the present invention, as described above, the controller 15 of the small marine vessel 10 is configured or programmed to perform a control to transmit, via the communicator 14 of the small marine vessel 10 to the information terminal 20 configured or programmed to communicate with the communicator 14 and to define and function as the warning application 60 to issue the predetermined warning based on the location information P1 of the small marine vessel 10, the start signal S to start the warning application 60 when the engine 11 is started. Accordingly, when the engine 11 of the small marine vessel 10 is started, the start signal S is transmitted to the information terminal 20 including the warning application 60 to issue the predetermined warning based on the location information P1 of the small marine vessel 10, to start the warning application 60. That is, even when the warning application 60 has not been started on the information terminal 20, the warning application 60 is started on the information terminal 20 when the engine 11 of the small marine vessel 10 is started. Consequently, the possibility that the vessel operator 90 forgets to start the warning application 60 on the information terminal 20 to issue the predetermined warning based on the location information P1 of the small marine vessel 10 when the vessel operator 90 operates the small marine vessel 10 is reduced or prevented.

According to an example embodiment of the present invention, as described above, the warning application 60 is operable to warn the vessel operator 90 of the small marine vessel 10 that the small marine vessel 10 has exceeded the speed limit in the speed restricted area A1 in which the speed of the small marine vessel 10 is restricted, and/or that the small marine vessel 10 has entered the entry prohibited area A2 in which entry of the small marine vessel 10 is prohibited. Accordingly, the possibility that the vessel operator 90 forgets to start the application to warn the vessel operator 90 of the small marine vessel 10 that the small marine vessel 10 has exceeded the speed limit in the speed restricted area A1, and/or that the small marine vessel 10 has entered the entry prohibited area A2 when the vessel operator 90 operates the small marine vessel 10 is reduced or prevented.

According to an example embodiment of the present invention, as described above, the controller 15 of the small marine vessel 10 is configured or programmed to perform a control to determine whether or not the engine 11 has been started based on the rotation speed of the engine 11. Accordingly, for example, unlike a case in which it is determined whether or not the engine 11 has been started based on whether or not a switch has been pressed to start the engine 11, it is reliably determined whether or not the engine 11 has actually been started based on the rotation speed of the engine 11. Consequently, the possibility that the start signal S is transmitted to the information terminal 20 to start the warning application 60 when the engine 11 has not been started is reduced or prevented.

According to an example embodiment of the present invention, as described above, the information terminal 20 is configured or programmed to start the warning application 60 when the start signal S has been received and the current location of the information terminal 20 is over water. Accordingly, the possibility that the warning application 60 is started on the information terminal 20 when the start signal S has been transmitted from the small marine vessel 10 but the current location of the information terminal 20 is on land is reduced or prevented. That is, the possibility that the warning application 60 is started on the information terminal 20 when the start signal S has been transmitted from the small marine vessel 10 but the vessel operator 90 does not operate the small marine vessel 10 is reduced or prevented. Consequently, the possibility that the warning application 60 is started on the information terminal 20 when it is not necessary to start the warning application 60 on the information terminal 20 is reduced or prevented.

According to an example embodiment of the present invention, as described above, the information terminal 20 is configured or programmed to acquire the location information P2 of the information terminal 20 using the satellite positioning system 40. Furthermore, the information terminal 20 is configured or programmed to not start the warning application 60 when it is determined that the information terminal 20 is on land based on the location information P2 of the information terminal 20 even when the start signal S has been transmitted from the small marine vessel 10. Accordingly, the information terminal 20 easily determines whether or not the information terminal 20 is on land based on the location information P2 of the information terminal 20 acquired by the satellite positioning system 40. That is, the information terminal 20 easily determines whether or not the warning application 60 is started. Consequently, the possibility that the warning application 60 is started on the information terminal 20 when it is not necessary to start the warning application 60 on the information terminal 20 is easily reduced or prevented. Furthermore, the information terminal 20 (especially a portable information terminal 20) often includes the function of the satellite positioning system 40 (such as a GPS), and thus in such a case, it is not necessary to install new software for the satellite positioning system 40 on the information terminal 20.

According to an example embodiment of the present invention, as described above, the controller 15 of the small marine vessel 10 is configured or programmed to acquire the location information P1 of the small marine vessel 10 using the satellite positioning system 40. Furthermore, the controller 15 of the small marine vessel 10 is configured or programmed to perform a control to not transmit the start signal S to the information terminal 20 when the controller 15 determines that the small marine vessel 10 is on land based on the location information P1 of the small marine vessel 10 even when the engine 11 has been started. Accordingly, the controller 15 of the small marine vessel 10 easily determines whether or not the small marine vessel 10 is on land based on the location information P1 of the small marine vessel 10 acquired by the satellite positioning system 40. That is, the controller 15 of the small marine vessel 10 easily determines whether or not the start signal S is transmitted to the information terminal 20 to start the warning application 60. Consequently, the possibility that the warning application 60 is started on the information terminal 20 when it is not necessary to start the warning application 60 on the information terminal 20 is easily reduced or prevented.

According to an example embodiment of the present invention, as described above, the small marine vessel 10 includes the jet propulsion thruster 13 to generate a thrust using the driving force of the engine 11. Furthermore, the controller 15 of the small marine vessel 10 is configured or programmed to perform a control to not transmit the start signal S to the information terminal 20 when the controller 15 determines that the small marine vessel 10 is on land by estimating whether or not the thruster 13 is underwater based on the load on the engine 11 even when the engine 11 has been started. Accordingly, the controller 15 of the small marine vessel 10 easily determines whether or not the small marine vessel 10 is on land by estimating whether or not the jet propulsion thruster 13 is underwater based on the load on the engine 11. That is, the controller 15 of the small marine vessel 10 easily determines whether or not the start signal S is transmitted to the information terminal 20 to start the warning application 60. Consequently, the possibility that the warning application 60 is started on the information terminal 20 when it is not necessary to start the warning application 60 on the information terminal 20 is easily reduced or prevented.

According to an example embodiment of the present invention, as described above, the controller 15 of the small marine vessel 10 is configured or programmed to perform a control to transmit the start signal S to the information terminal 20 via the communicator 14 using, e.g., Bluetooth™ when the engine 11 is started. Accordingly, using, e.g., Bluetooth™, which is optimal for short-distance communication, the start signal S is easily transmitted from the communicator 14 of the small marine vessel 10 to the information terminal 20.

According to an example embodiment of the present invention, as described above, the controller 15 of the small marine vessel 10 is configured or programmed to perform a control to limit the output of the engine 11 when the warning application 60 has not been started on the information terminal 20. Even when information terminal 20 includes the warning application 60, the warning application 60 may not function when the vessel operator 90 operates the small marine vessel 10. The warning application 60 may not function, for example, when the information terminal 20 is not on, when communication between the communicator 14 of the small marine vessel 10 and the information terminal 20 is not established, when the warning application 60 is not started, etc. The warning application 60 is not started, for example, when the warning application 60 is not started normally on the information terminal 20 even when the small marine vessel 10 has transmitted the start signal S to the information terminal 20 to start the warning application 60, when the vessel operator 90 (intentionally or unintentionally) stops the warning application 60 that had been started on the information terminal 20, etc. When the warning application 60 does not function when the vessel operator 90 is operating the small marine vessel 10, the warning application 60 of the information terminal 20 is not effectively used to issue the predetermined warning based on the location information P1 of the small marine vessel 10. Therefore, it is desired to reliably allow the warning application 60 to function on the information terminal 20 to issue the predetermined warning based on the location information P1 of the small marine vessel 10 when the vessel operator 90 operates the small marine vessel 10. In order to solve such a problem, the structure described above has been devised. Thus, when the warning application 60 has not been started on the information terminal 20, the output of the engine 11 is limited. That is, when the warning application 60 has not been started on the information terminal 20, the vessel operator 90 is prompted to start the warning application 60 on the information terminal 20 in order to cancel the limitation on the output of the engine 11. Consequently, when the vessel operator 90 operates the small marine vessel 10, the warning application 60 is reliably allowed to function on the information terminal 20 to issue the predetermined warning based on the location information P1 of the small marine vessel 10.

According to an example embodiment of the present invention, as described above, the controller 15 of the small marine vessel 10 is configured or programmed to perform a control to limit the rotation speed of the engine 11 so as to limit the output of the engine 11 when the warning application 60 has not been started on the information terminal 20. Accordingly, the output of the engine 11 is easily limited by limiting the rotation speed of the engine 11. Consequently, when the vessel operator 90 operates the small marine vessel 10, the warning application 60 is easily allowed to function on the information terminal 20 to issue the predetermined warning based on the location information P1 of the small marine vessel 10.

According to an example embodiment of the present invention, as described above, the controller 15 of the small marine vessel 10 is configured or programmed to perform a control to limit the maximum output of the engine 11 to at least about 40% and not more than about 70% of the maximum output of the engine 11 (on which a limitation is not imposed) when the warning application 60 has not been started on the information terminal 20. Accordingly, the output of the engine 11 is limited to a greater extent as compared with a case in which the maximum output of the engine 11 is limited to more than about 70% of the maximum output of the engine 11. That is, when the warning application 60 has not been started on the information terminal 20, the vessel operator 90 is more strongly prompted to start the warning application 60 on the information terminal 20. Consequently, when the vessel operator 90 operates the small marine vessel 10, the warning application 60 is reliably allowed to function on the information terminal 20 to issue the predetermined warning based on the location information P1 of the small marine vessel 10.

According to an example embodiment of the present invention, as described above, the information terminal 20 includes the touch panel 21. Furthermore, the information terminal 20 is configured or programmed to lock or unlock screen transitions on the touch panel 21 when the touch panel 21 receives the first operation 71 of drawing a figure clockwise and the second operation 72 of drawing a figure counterclockwise in succession while the warning application 60 is displayed on the touch panel 21. When the vessel operator 90 operates the small marine vessel 10, water droplets may adhere to the information terminal 20. In such a case, when the water droplets move on the touch panel 21 due to their own weight, wind pressure, or the like while the warning application 60 is displayed on the touch panel 21, the information terminal 20 may erroneously recognize that the touch panel 21 has been operated by the vessel operator 90. In such a case, the screen of the warning application 60 displayed on the touch panel 21 is transitioned to another screen without the intention of the vessel operator 90. Therefore, it is desired to reduce or prevent a transition of the screen of the warning application 60 displayed on the touch panel 21 of the information terminal 20 to another screen without the intention of the vessel operator 90. In order to solve such a problem, the structure described above has been devised. Thus, screen transitions on the touch panel 21 are locked or unlocked only when the first operation 71 of drawing a figure clockwise and the second operation 72 of drawing a figure counterclockwise are performed in succession on the touch panel 21 while the warning application 60 is displayed on the touch panel 21. It is considered that it is unlikely that a water droplet on the touch panel will move to draw a figure counterclockwise following moving to draw a figure clockwise. That is, it is difficult for a water droplet on the touch panel to move in the same way as the finger of the vessel operator 90 in the first operation 71 and the second operation 72 to lock or unlock screen transitions on the touch panel 21, and thus the possibility that the information terminal 20 erroneously recognizes that the touch panel 21 has been operated by the vessel operator 90 while the warning application 60 is displayed on the touch panel 21 is reduced or prevented. Consequently, a transition of the screen of the warning application 60 displayed on the touch panel 21 of the information terminal 20 to another screen without the intention of the vessel operator 90 is reduced or prevented.

According to an example embodiment of the present invention, as described above, the information terminal 20 is configured or programmed to lock or unlock screen transitions on the touch panel 21 when the touch panel 21 receives the first operation 71 and the second operation 72 of drawing a figure of a different size from the figure of the first operation 71 in succession while the warning application 60 is displayed on the touch panel 21. Accordingly, as compared with a case in which a figure of the same size is drawn in the first operation 71 and the second operation 72, it is more difficult for a water droplet on the touch panel to move in the same way as the finger of the vessel operator 90 in the first operation 71 and the second operation 72, and thus the possibility that the information terminal 20 erroneously recognizes that the touch panel 21 has been operated by the vessel operator 90 is further reduced or prevented. Consequently, a transition of the screen of the warning application 60 displayed on the touch panel 21 of the information terminal 20 to another screen without the intention of the vessel operator 90 is further reduced or prevented.

According to an example embodiment of the present invention, as described above, the information terminal 20 is configured or programmed to lock or unlock screen transitions on the touch panel 21 when the touch panel 21 receives the first operation 71 of drawing a circle and the second operation 72 of drawing a circle in succession while the warning application 60 is displayed on the touch panel 21. Accordingly, as compared with a case in which a figure (such as a quadrangle or a triangle) other than a circle is drawn in the first operation 71 and the second operation 72, the number of strokes of the figure drawn in the first operation 71 and the second operation 72 is smaller, and thus the operational burden on the vessel operator 90 to lock or unlock screen transitions on the touch panel 21 is reduced.

In the methods according to the example embodiments of the present invention, the following advantageous effects are achieved.

According to an example embodiment of the present invention, as described above, the vessel operator warning support method includes step S13 in which the controller 15 of the small marine vessel 10 performs a control to transmit, via the communicator 14 of the small marine vessel 10 to the information terminal 20 configured or programmed to communicate with the communicator 14 and to define and function as the warning application 60 to issue the predetermined warning based on the location information P1 of the small marine vessel 10, the start signal S to start the warning application 60 when the controller 15 determines that the engine 11 has been started. Accordingly, similarly to the structure of the example embodiments described above, even when the warning application 60 has not been started on the information terminal 20, the warning application 60 is started on the information terminal 20 when the engine 11 of the small marine vessel 10 is started. Consequently, similarly to the structure of the example embodiments described above, the possibility that the vessel operator 90 forgets to start the warning application 60 on the information terminal 20 to issue the predetermined warning based on the location information P1 of the small marine vessel 10 when the vessel operator 90 operates the small marine vessel 10 is reduced or prevented.

According to an example embodiment of the present invention, as described above, step S13 of performing a control to transmit the start signal S includes a step in which the small marine vessel 10 transmits the start signal S to start the warning application 60 to warn the vessel operator 90 of the small marine vessel 10 that the small marine vessel 10 has exceeded the speed limit in the speed restricted area A1 in which the speed of the small marine vessel 10 is restricted, and/or that the small marine vessel 10 has entered the entry prohibited area A2 in which entry of the small marine vessel 10 is prohibited. Accordingly, similarly to the structure of the example embodiments described above, the possibility that the vessel operator 90 forgets to start the waring application 60 to warn the vessel operator 90 of the small marine vessel 10 that the small marine vessel 10 has exceeded the speed limit in the speed restricted area A1, and/or that the small marine vessel 10 has entered the entry prohibited area A2 when the vessel operator 90 operates the small marine vessel 10 is reduced or prevented.

According to an example embodiment of the present invention, as described above, step S11 of determining whether or not the engine 11 has been started includes a step in which the controller 15 of the small marine vessel 10 determines whether or not the engine 11 has been started based on the rotation speed of the engine 11. Accordingly, similarly to the structure of the example embodiments described above, for example, unlike a case in which it is determined whether or not the engine 11 has been started based on whether or not a switch has been pressed to start the engine 11, it is reliably determined whether or not the engine 11 has actually been started based on the rotation speed of the engine 11. Consequently, similarly to the structure of the example embodiments described above, the possibility that the start signal S is transmitted to the information terminal 20 to start the warning application 60 when the engine 11 has not been started is reduced or prevented.

According to an example embodiment of the present invention, as described above, the vessel operator warning support method includes step S21 in which the information terminal 20 determines whether or not the start signal S has been received, step S22 in which the information terminal 20 determines whether or not the current location of the information terminal 20 is over water when the start signal S has been received, and step S23 in which the information terminal 20 starts the warning application 60 when the information terminal 20 determines that the current location of the information terminal 20 is over water. Accordingly, similarly to the structure of the example embodiments described above, the possibility that the warning application 60 is started on the information terminal 20 when the start signal S has been transmitted from the small marine vessel 10 but the vessel operator 90 does not operate the small marine vessel 10 is reduced or prevented. Consequently, similarly to the structure of the example embodiments described above, the possibility that the warning application 60 is started on the information terminal 20 when it is not necessary to start the warning application 60 on the information terminal 20 is reduced or prevented.

According to an example embodiment of the present invention, as described above, step S23 of starting the warning application 60 includes a step in which the information terminal 20 does not start the warning application 60 when it is determined that the information terminal 20 is on land based on the location information P2 of the information terminal 20 even when the start signal S has been transmitted from the small marine vessel 10. Accordingly, similarly to the structure of the example embodiments described above, the information terminal 20 easily determines whether or not the warning application 60 is started. Consequently, similarly to the structure of the example embodiments described above, the possibility that the warning application 60 is started on the information terminal 20 when it is not necessary to start the warning application 60 on the information terminal 20 is easily reduced or prevented. Furthermore, similarly to the structure of the example embodiments described above, the information terminal 20 (especially a portable information terminal 20) often includes the function of the satellite positioning system 40 (such as a GPS), and thus in such a case, it is not necessary to install new software for the satellite positioning system 40 on the information terminal 20.

According to an example embodiment of the present invention, as described above, step S13 of performing a control to transmit the start signal S includes a step in which the controller 15 of the small marine vessel 10 performs a control to not transmit the start signal S to the information terminal 20 when the controller 15 determines that the small marine vessel 10 is on land based on the location information P1 of the small marine vessel 10 even when the engine 11 has been started. Accordingly, similarly to the structure of the example embodiments described above, the controller 15 of the small marine vessel 10 easily determines whether or not the start signal S is transmitted to the information terminal 20 to start the warning application 60. Consequently, similarly to the structure of the example embodiments described above, the possibility that the warning application 60 is started on the information terminal 20 when it is not necessary to start the warning application 60 on the information terminal 20 is easily reduced or prevented.

According to an example embodiment of the present invention, as described above, step S13 of performing a control to transmit the start signal S includes a step in which the controller 15 of the small marine vessel 10 performs a control to not transmit the start signal S to the information terminal 20 when the controller 15 determines that the small marine vessel 10 is on land by estimating whether or not the thruster 13 is underwater based on the load on the engine 11 even when the engine 11 has been started. Accordingly, similarly to the structure of the example embodiments described above, the controller 15 of the small marine vessel 10 easily determines whether or not the start signal S is transmitted to the information terminal 20 to start the warning application 60. Consequently, similarly to the structure of the example embodiments described above, the possibility that the warning application 60 is started on the information terminal 20 when it is not necessary to start the warning application 60 on the information terminal 20 is easily reduced or prevented.

According to an example embodiment of the present invention, as described above, step S13 of performing a control to transmit the start signal S includes a step in which the controller 15 of the small marine vessel 10 performs a control to transmit the start signal S to the information terminal 20 via the communicator 14 using, e.g., Bluetooth™ when the controller 15 determines that the engine 11 has been started. Accordingly, similarly to the structure of the example embodiments described above, using Bluetooth™, which is optimal for short-distance communication, the start signal S is easily transmitted from the communicator 14 of the small marine vessel 10 to the information terminal 20.

According to an example embodiment of the present invention, as described above, the vessel operator warning support method includes step S31 of determining whether or not the warning application 60 has been started on the information terminal 20 and step S32 in which the controller 15 of the small marine vessel 10 performs a control to limit the output of the engine 11 when the warning application 60 has not been started on the information terminal 20. Accordingly, similarly to the structure of the example embodiments described above, when the warning application 60 has not been started on the information terminal 20, the vessel operator 90 is prompted to start the warning application 60 on the information terminal 20 in order to cancel the limitation on the output of the engine 11. Consequently, similarly to the structure of the example embodiments described above, when the vessel operator 90 operates the small marine vessel 10, the warning application 60 is allowed to function on the information terminal 20 to issue the predetermined warning based on the location information P1 of the small marine vessel 10.

According to an example embodiment of the present invention, as described above, step S32 of performing a control to limit the output of the engine 11 includes a step in which the controller 15 of the small marine vessel 10 performs a control to limit the rotation speed of the engine 11 when the warning application 60 has not been started on the information terminal 20. Accordingly, similarly to the structure of the example embodiments described above, the output of the engine 11 is easily limited by limiting the rotation speed of the engine 11. Consequently, similarly to the structure of the example embodiments described above, when the vessel operator 90 operates the small marine vessel 10, the warning application 60 is easily allowed to function on the information terminal 20 to issue the predetermined warning based on the location information P1 of the small marine vessel 10.

According to an example embodiment of the present invention, as described above, step S32 of performing a control to limit the output of the engine 11 includes a step in which the controller 15 of the small marine vessel 10 performs a control to limit the maximum output of the engine 11 to at least about 40% and not more than about 70% of the maximum output of the engine 11 (on which a limitation is not imposed) when the warning application 60 has not been started on the information terminal 20. Accordingly, similarly to the structure of the example embodiments described above, when the warning application 60 has not been started on the information terminal 20, the vessel operator 90 is more strongly prompted to start the warning application 60 on the information terminal 20. Consequently, similarly to the structure of the example embodiments described above, when the vessel operator 90 operates the small marine vessel 10, the warning application 60 is reliably allowed to function on the information terminal 20 to issue the predetermined warning based on the location information P1 of the small marine vessel 10.

According to an example embodiment of the present invention, as described above, the vessel operator warning support method includes step S41 of determining whether or not the touch panel 21 has received the first operation 71 of drawing a figure clockwise and the second operation 72 of drawing a figure counterclockwise in succession while the warning application 60 is displayed on the touch panel 21 of the information terminal 20 and step S42 of locking or unlocking screen transitions on the touch panel 21 when the touch panel 21 has received the first operation 71 and the second operation 72 in succession while the warning application 60 is displayed on the touch panel 21. Accordingly, similarly to the structure of the example embodiments described above, it is difficult for a water droplet on the touch panel 21 to move in the same way as the finger of the vessel operator 90 in the first operation 71 and the second operation 72 to lock or unlock screen transitions on the touch panel 21, and thus the possibility that the information terminal 20 erroneously recognizes that the touch panel 21 has been operated by the vessel operator 90 while the warning application 60 is displayed on the touch panel 21 is reduced or prevented. Consequently, similarly to the structure of the example embodiments described above, a transition of the screen of the warning application 60 displayed on the touch panel 21 of the information terminal 20 to another screen without the intention of the vessel operator 90 is reduced or prevented.

According to an example embodiment of the present invention, as described above, step S42 of locking or unlocking screen transitions on the touch panel 21 includes a step in which the information terminal 20 locks or unlocks screen transitions on the touch panel 21 when the touch panel 21 receives the first operation 71 and the second operation 72 of drawing a figure of a different size from the figure of the first operation 71 in succession while the warning application 60 is displayed on the touch panel 21. Accordingly, similarly to the structure of the example embodiments described above, as compared with a case in which a figure of the same size is drawn in the first operation 71 and the second operation 72, it is more difficult for a water droplet on the touch panel 21 to move in the same way as the finger of the vessel operator 90 in the first operation 71 and the second operation 72, and thus the possibility that the information terminal 20 erroneously recognizes that the touch panel 21 has been operated by the vessel operator 90 is further reduced or prevented.

Consequently, similarly to the structure of the example embodiments described above, a transition of the screen of the warning application 60 displayed on the touch panel 21 of the information terminal 20 to another screen without the intention of the vessel operator 90 is further reduced or prevented.

According to an example embodiment of the present invention, as described above, step S42 of locking or unlocking screen transitions on the touch panel 21 includes a step in which the information terminal 20 locks or unlocks screen transitions on the touch panel 21 when the touch panel 21 receives the first operation 71 of drawing a circle and the second operation 72 of drawing a circle in succession while the warning application 60 is displayed on the touch panel 21. Accordingly, similarly to the structure of the example embodiments described above, as compared with a case in which a figure (such as a quadrangle or a triangle) other than a circle is drawn in the first operation 71 and the second operation 72, the number of strokes of the figure drawn in the first operation 71 and the second operation 72 is smaller, and thus the operational burden on the vessel operator 90 to lock or unlock screen transitions on the touch panel 21 is reduced.

The example embodiments of the present invention described above are illustrative in all points and not restrictive. The extent of the present invention is not defined by the above description of the example embodiments but by the scope of the claims, and all modifications (modified examples) within the meaning and range equivalent to the scope of the claims are further included.

For example, while the example in which in the second operation 72 of drawing a figure counterclockwise, a figure smaller than the figure of the first operation 71 of drawing a figure clockwise is drawn has been shown in example embodiments described above, the present invention is not restricted to this. In an example embodiment of the present invention, as in an information terminal 220 according to a first modified example shown in FIG. 10, in a second operation 272 of drawing a figure counterclockwise, a figure larger than the figure of a first operation 271 of drawing a figure clockwise may be drawn.

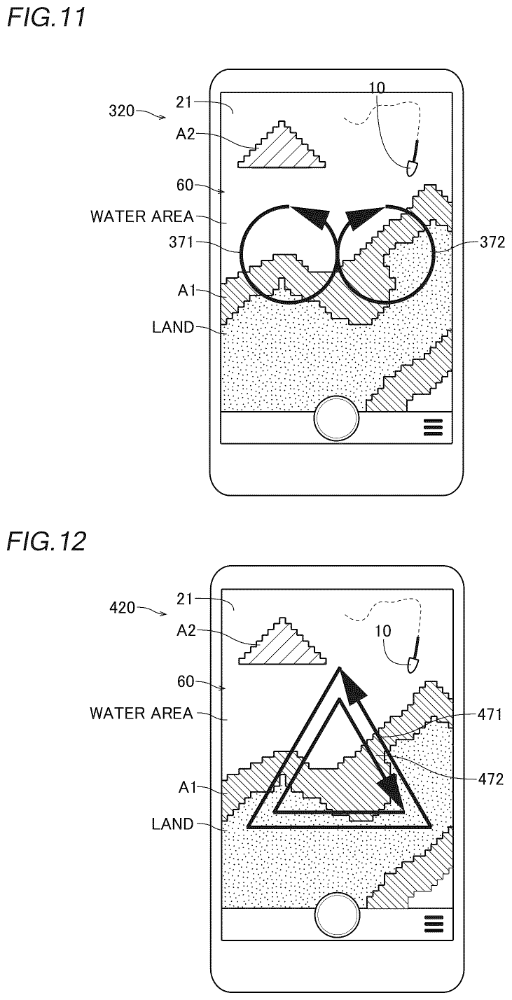

While the example in which in the second operation 72 of drawing a figure counterclockwise, a concentric circle with the first operation 71 of drawing a figure clockwise is drawn has been shown in example embodiments described above, the present invention is not restricted to this. In an example embodiment of the present invention, as in a second modified example shown in FIG. 11, an information terminal 320 may lock or unlock screen transitions on a touch panel 21 when the touch panel 21 receives, in succession, a first operation 371 and a second operation 372 performed adjacent to each other so as to draw a figure eight while the warning application 60 is displayed on the touch panel 21. That is, the step of locking or unlocking screen transitions on the touch panel 21 may include a step in which the information terminal 20 locks or unlocks screen transitions on the touch panel 21 when the touch panel 21 receives, in succession, the first operation 371 and the second operation 372 performed adjacent to each other so as to draw a figure eight while the warning application 60 is displayed on the touch panel 21. In such a case, a figure eight is drawn through the first operation 371 and the second operation 372 such that the number of strokes of the figure drawn through the first operation 371 and the second operation 372 is reduced to one, and thus as compared with a case in which a figure eight is not drawn through the first operation 371 and the second operation 372, the operational burden on the vessel operator 90 to lock or unlock screen transitions on the touch panel 21 is reduced.

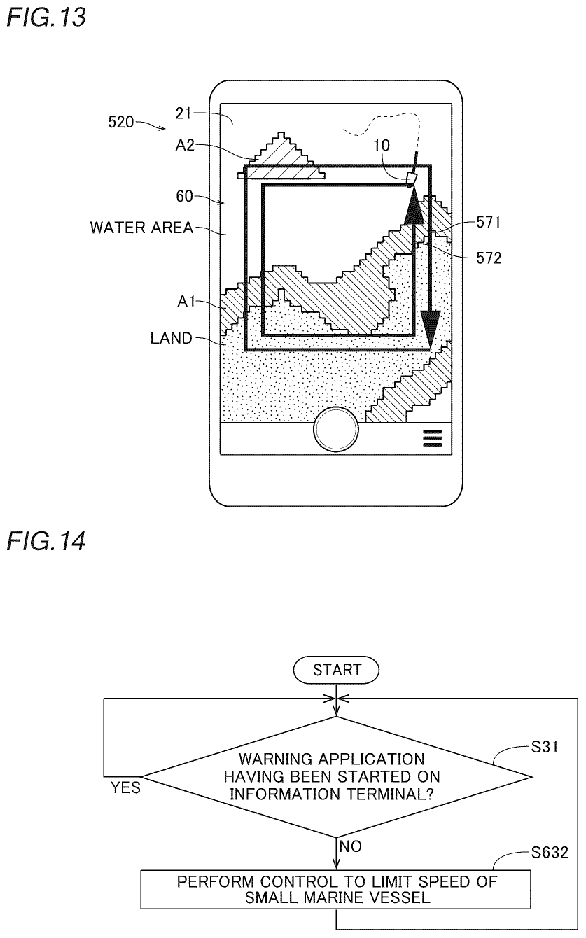

While the example in which the information terminal 20 locks or unlocks screen transitions on the touch panel 21 when the touch panel 21 receives the first operation 71 of drawing a circle and the second operation 72 of drawing a circle in succession while the warning application 60 is displayed on the touch panel 21 has been shown in example embodiments described above, the present invention is not restricted to this. In an example embodiment of the present invention, as in a third modified example shown in FIG. 12, an information terminal 420 may lock or unlock screen transitions on a touch panel 21 when the touch panel 21 receives a first operation 471 of drawing a triangle and a second operation 472 of drawing a triangle in succession while a warning application 60 is displayed on the touch panel 21, or as in a fourth modified example shown in FIG. 13, an information terminal 520 may lock or unlock screen transitions on a touch panel 21 when the touch panel 21 receives a first operation 571 of drawing a quadrangle and a second operation 572 of drawing a quadrangle in succession while a warning application 60 is displayed on the touch panel 21.

While the example in which the information terminal 20 locks or unlocks screen transitions on the touch panel 21 when the touch panel 21 receives the first operation 71 and the second operation 72 of drawing a figure of a different size from the figure of the first operation 71 in succession while the warning application 60 is displayed on the touch panel 21 has been shown in example embodiments described above, the present invention is not restricted to this. In an example embodiment of the present invention, the information terminal may lock or unlock screen transitions on the touch panel when the touch panel receives the first operation and the second operation of drawing a figure of substantially the same size as the figure of the first operation in succession while the warning application is displayed on the touch panel.

While the example in which the information terminal 20 locks or unlocks screen transitions on the touch panel 21 when the touch panel 21 receives the first operation 71 of drawing a figure clockwise and the second operation 72 of drawing a figure counterclockwise in succession while the warning application 60 is displayed on the touch panel 21 has been shown in example embodiments described above, the present invention is not restricted to this. In an example embodiment of the present invention, the information terminal may lock or unlock screen transitions on the touch panel when the touch panel receives an operation other than the first operation and the second operation described above while the warning application is displayed on the touch panel.

While the example in which the controller 15 of the small marine vessel 10 performs a control to limit the maximum output of the engine 11 to at least about 40% and not more than about 70% of the maximum output of the engine 11 (on which a limitation is not imposed) when the warning application 60 has not been started on the information terminal 20 has been shown in example embodiments described above, the present invention is not restricted to this. In an example embodiment of the present invention, the controller of the small marine vessel may perform a control to limit the maximum output of the engine to less than about 40% of the maximum output of the engine (on which a limitation is not imposed) when the warning application has not been started on the information terminal.

While the example in which the controller 15 of the small marine vessel 10 performs a control to limit the output of the engine 11 when the warning application 60 has not been started on the information terminal 20 has been shown in example embodiments described above, the present invention is not restricted to this. In an example embodiment of the present invention, the controller of the small marine vessel may not perform a control to limit the output of the engine even when the warning application has not been started on the information terminal.

While the example in which the controller 15 of the small marine vessel 10 performs a control to transmit the start signal S to the information terminal 20 via the communicator 14 using, e.g., Bluetooth™ when the engine 11 is started has been shown in example embodiments described above, the present invention is not restricted to this. In an example embodiment of the present invention, the controller of the small marine vessel may perform a control to transmit the start signal to the information terminal via the communicator using a communication standard other than Bluetooth™ when the engine is started.

While the example in which the controller 15 of the small marine vessel 10 performs a control to not transmit the start signal S to the information terminal 20 when the controller 15 determines that the small marine vessel 10 is on land by estimating whether or not the thruster 13 is underwater based on the load on the engine 11 even when the engine 11 has been started has been shown in example embodiments described above, the present invention is not restricted to this. In an example embodiment of the present invention, the controller of the small marine vessel may perform a control to transmit the start signal to the information terminal even when the controller determines that the small marine vessel is on land by estimating whether or not the thruster is underwater based on the load on the engine when the engine has been started. Alternatively, the controller of the small marine vessel may transmit information regarding the load on the engine to the information terminal, and the information terminal may determine whether or not the small marine vessel is on land based on the information regarding the load on the engine.

While the example in which the controller 15 of the small marine vessel 10 performs a control to not transmit the start signal S to the information terminal 20 when the controller 15 determines that the small marine vessel 10 is on land based on the location information P1 of the small marine vessel 10 even when the engine 11 has been started has been shown in example embodiments described above, the present invention is not restricted to this. In an example embodiment of the present invention, the controller of the small marine vessel may perform a control to transmit the start signal to the information terminal even when the controller determines that the small marine vessel is on land based on the location information of the small marine vessel when the engine has been started. Alternatively, the controller of the small marine vessel may transmit the location information of the small marine vessel to the information terminal, and the information terminal may determine whether or not the small marine vessel is on land based on the location information of the small marine vessel.

While the example in which the information terminal 20 does not start the warning application 60 when it is determined that the information terminal 20 is on land based on the location information P2 of the information terminal 20 even when the start signal S has been transmitted from the small marine vessel 10 has been shown in example embodiments described above, the present invention is not restricted to this. In an example embodiment of the present invention, the information terminal may start the warning application even when it is determined that the information terminal is on land based on the location information of the information terminal when the start signal has been transmitted from the small marine vessel 10.

While the example in which the controller 15 of the small marine vessel 10 performs a control to limit the output of the engine 11 when the warning application 60 has not been started on the information terminal 20 has been shown in example embodiments described above, the present invention is not restricted to this. In an example embodiment of the present invention, as in a fifth modified example shown in FIG. 14, the controller of the small marine vessel may perform a control to limit the speed of the small marine vessel when the warning application has not been started on the information terminal (step S632). Alternatively, the controller of the small marine vessel may not perform a control to limit the output of the engine or the speed of the small marine vessel when the warning application has not been started on the information terminal.

While the example in which the controller 15 of the small marine vessel 10 performs a control to determine whether or not the engine 11 has been started based on the rotation speed of the engine 11 has been shown in example embodiments described above, the present invention is not restricted to this. In an example embodiment of the present invention, the controller of the small marine vessel may perform a control to determine whether or not the engine has been started based on information other than the rotation speed of the engine.

While the example in which the warning application 60 warns the vessel operator 90 of the small marine vessel 10 that the small marine vessel 10 has exceeded the speed limit in the speed restricted area A1 and/or that the small marine vessel 10 has entered the entry prohibited area A2 in which entry of the small marine vessel 10 is prohibited has been shown in example embodiments described above, the present invention is not restricted to this. In an example embodiment of the present invention, the warning application may warn the vessel operator of the small marine vessel that the small marine vessel has exceeded the speed limit in the speed restricted area or that the small marine vessel has entered the entry prohibited area in which entry of the small marine vessel is prohibited.

While the example in which the small marine vessel 10 is a water jet propulsion boat (wet bike) has been shown in example embodiments described above, the present invention is not restricted to this. In an example embodiment of the present invention, the small marine vessel may be a pleasure boat, for example.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A vessel operator warning support system comprising:
a marine vessel including an engine, a controller, and a communicator; and
an information terminal configured or programmed to communicate with the communicator of the marine vessel and to define and function as a warning application to issue a predetermined warning based on location information of the marine vessel; wherein
the controller is configured or programmed to perform a control to transmit, via the communicator to the information terminal, a start signal to start the warning application when the engine is started.

2. The vessel operator warning support system according to claim 1, wherein the warning application is operable to warn a vessel operator of the marine vessel that the marine vessel has exceeded a speed limit in a speed restricted area in which a speed of the marine vessel is restricted, and/or that the marine vessel has entered an entry prohibited area in which entry of the marine vessel is prohibited.

3. The vessel operator warning support system according to claim 1, wherein the controller is configured or programmed to perform a control to determine whether or not the engine has been started based on a rotation speed of the engine.

4. The vessel operator warning support system according to claim 1, wherein the information terminal is configured or programmed to start the warning application when the start signal has been received and a current location of the information terminal is over water.

5. The vessel operator warning support system according to claim 4, wherein the information terminal is configured or programmed to acquire location information of the information terminal using a satellite positioning system, and to not start the warning application when it is determined that the information terminal is on land based on the location information of the information terminal even when the start signal has been transmitted from the marine vessel.

6. The vessel operator warning support system according to claim 1, wherein the controller is configured or programmed to acquire the location information of the marine vessel using a satellite positioning system, and to perform a control to not transmit the start signal to the information terminal when the controller determines that the marine vessel is on land based on the location information of the marine vessel even when the engine has been started.

7. The vessel operator warning support system according to claim 1, wherein
the marine vessel includes a jet propulsion thruster to generate a thrust using a driving force of the engine; and
the controller is configured or programmed to perform a control to not transmit the start signal to the information terminal when the controller determines that the marine vessel is on land by estimating whether or not the thruster is underwater based on a load on the engine even when the engine has been started.

8. The vessel operator warning support system according to claim 1, wherein the controller is configured or programmed to perform a control to transmit the start signal to the information terminal via the communicator using short-range wireless technology when the engine is started.

9. The vessel operator warning support system according to claim 1, wherein the controller is configured or programmed to perform a control to limit an output of the engine or a speed of the marine vessel when the warning application has not been started on the information terminal.

10. The vessel operator warning support system according to claim 9, wherein the controller is configured or programmed to perform a control to limit a rotation speed of the engine to limit the output of the engine when the warning application has not been started on the information terminal.

11. The vessel operator warning support system according to claim 9, wherein the controller is configured or programmed to perform a control to limit a maximum output of the engine to at least about 40% and not more than about 70% of a maximum output of the engine on which a limitation is not imposed when the warning application has not been started on the information terminal.

12. The vessel operator warning support system according to claim 1, wherein the information terminal includes a touch panel, and is configured or programmed to lock or unlock a screen transition on the touch panel when the touch panel receives a first operation of drawing a figure clockwise and a second operation of drawing a figure counterclockwise in succession while the warning application is displayed on the touch panel.

13. The vessel operator warning support system according to claim 12, wherein the information terminal is configured or programmed to lock or unlock the screen transition on the touch panel when the touch panel receives the first operation and the second operation of drawing the figure of a different size from the figure of the first operation in succession while the warning application is displayed on the touch panel.

14. The vessel operator warning support system according to claim 12, wherein the information terminal is configured or programmed to lock or unlock the screen transition on the touch panel when the touch panel receives the first operation of drawing a circle and the second operation of drawing a circle in succession while the warning application is displayed on the touch panel.

15. The vessel operator warning support system according to claim 12, wherein the information terminal is configured or programmed to lock or unlock the screen transition on the touch panel when the touch panel receives, in succession, the first operation and the second operation performed adjacent to each other so as to draw a figure eight while the warning application is displayed on the touch panel.

16. A vessel operator warning support method comprising:
determining with a controller of a marine vessel including an engine, the controller, and a communicator, whether or not the engine has been started; and
performing with the controller of the marine vessel a control to transmit, via the communicator of the marine vessel to an information terminal configured or programmed to communicate with the communicator and to define and function as a warning application to issue a predetermined warning based on location information of the marine vessel, a start signal to start the warning application when the controller determines that the engine has been started.

17. The vessel operator warning support method according to claim 16, further comprising:
determining whether or not the warning application has been started on the information terminal; and
performing with the controller a control to limit an output of the engine or a speed of the marine vessel when the warning application has not been started on the information terminal.

18. The vessel operator warning support method according to claim 16, further comprising:
determining whether or not a touch panel of the information terminal has received a first operation of drawing a figure clockwise and a second operation of drawing a figure counterclockwise in succession while the warning application is displayed on the touch panel; and
locking or unlocking a screen transition on the touch panel when the touch panel has received the first operation and the second operation in succession while the warning application is displayed on the touch panel.
